(19) United States
(12) Patent Application Publication
(10) Pub. No.: US 2005/0132205 A1
(43) Pub. Date: Jun. 16, 2005

(54) Apparatus, methods and computer programs for identifying matching resources within a data processing network

(75) Inventors: Sudarshan Palliyil, Bangalore (IN); Shivakumara Venkat Shamurthy, Bangalore (IN); Tejasvi Aswathanarayana, Bangalore (IN)

Correspondence Address: ANTHONY ENGLAND, PO Box 5307, AUSTIN, TX, 78763-5307, US

(73) Assignee: International Business Machines Corporation, Armonk, NY (US)

(21) Appl. No.: 10/735,509

(22) Filed: Dec. 12, 2003

(51) Int. Cl. H04L 9/32

(52) U.S. Cl. 713/188

(57) ABSTRACT

Provided are methods, apparatus and computer programs for identifying matching resources (data files and executable files) within a data processing network, by comparison of hash values computed for each of a set of resources. A match between a newly computed hash value and a previously computed hash value for a resource indicates that the resource has not changed since the previous computation. A match between hash values for different resources indicates that they are identical. The result of the comparison can be used to determine whether a virus scan is currently required for a resource, on the basis that a resource which is unchanged since it was classified virus-free remains virus-free and a resource which is identical to a virus-scanned resource does not require duplication of the virus scan. The methods, apparatus and computer programs enable more efficient use of antivirus scanning or management of a backup copy process.

### FIELD OF INVENTION

The present invention provides methods, apparatus and computer programs for controlling performance of operations in a data processing system or network, such as for identifying replica files to enable more efficient use of operations such as antivirus scanning or management of a backup copy process.

### BACKGROUND

A computer virus is a piece of computer program code that causes unexpected and usually undesirable events within a computer system. Some viruses are very harmful, erasing data or causing the computer's hard disk to require reformatting. A virus is often disguised as something else, and many are designed to be automatically spread to other computers. Viruses can be transmitted as attachments to an e-mail or as downloadable files.

File infector viruses typically attach themselves to program files, usually selected .COM or .EXE files although some viruses can infect any executable program. When the program is loaded, the virus is loaded as well. A file infector virus may arrive at a computer as a self-contained program or script sent as an attachment to an e-mail, or via an infected removable storage medium. System or boot-record infector viruses infect executable code found in certain system areas on a disk. They attach to the DOS boot sector on diskettes or the Master Boot Record on hard disks, and can make the computer's hard disk temporarily unusable. Macro viruses are among the most common viruses, but tend to do the least damage. Macro viruses can infect an application, such as inserting unwanted words or phrases when using a word processing application.

Because computer viruses are so common, easily transmitted and potentially harmful, anti-virus software is vital to protect against viruses.

Existing antivirus software scans each file for all known viruses that can affect that type of file. If there are N identical files located on M systems within a LAN, despite the files being identical, each of these N files is scanned by the antivirus program running on the respective local systems.

Additionally, no history is currently maintained about the files which have been scanned to indicate whether the file had been found to be virus-free in the previous scan or not. Regardless of whether the file has been designated as virus-free in a first scan, the file will be re-scanned in subsequent executions of the antivirus software.

Taking regular backups uses a lot of storage space, time and bandwidth. If identical files on different machines are backed up, a copy of each file is maintained in the backup for each machine even though the files are identical. Backup copies may be made even when the file being copied has not changed since the last backup.

The inventors of the present invention have identified the above issues, and the need for solutions that can mitigate one or more of the above-described problems.

### SUMMARY

A first embodiment of the invention provides a method for controlling scanning for computer viruses within a data processing network. Hash values are computed for each of a set of resources. In response to a requirement for a virus check, the computed hash values are compared with each other to identify resources having matching hash values. A virus scan is performed for a first resource. If the virus scan determines that the first resource is virus-free, a virus-free status is recorded for the first resource and for the identified resources having hash values matching the hash value of the first resource.

Hash values computed for a resource by applying a secure hash function to the bit pattern representing the resource are unique representations of the resource, and so a match between the hash values for two resources indicates that the resources are identical replicas. A method as above can avoid or reduce repetition of virus scanning for replicas of a resource, when the resource is classified virus-free as a result of scanning one of the replicas.

The term ‘virus’ as used in the present specification includes worms (self-replicating programs which may include viral payloads), trojan horses (apparently harmless files which contain viruses) and similar virulent, malicious or undesirable programs. For the purposes of this specification, a resource may be a single data file or executable file, or a group of files such as a Zip-compressed group of files (within a zip file), or the set of files which combine to form an application program or an operating system. An operating system or an application program is an example of a resource, but typically comprises multiple files which are each also referred to as resources or component resources. Hash values may be separately computed for each component resource. Applying a secure hash function to the bit pattern representing such files or groups of files, and comparing with other hash values, may involve significantly less processing than decompressing and virus scanning each file. A ‘replica’ in this context does not imply any different status from an ‘original’ instance of a resource. If an identical hash value is derived from each of N copies or instances of a file, the N copies or instances are identical and are referred to herein as N replicas.

According to one embodiment of the invention, a single read of a resource can be used both to enable computing the hash value for the resource and for performing a backup operation. If the comparison of hash values identifies matches, leading to a determination that some of the resources are replicas, the single copy of a resource read from secondary storage could be copied to multiple locations in backup storage to backup multiple replicas of the resource.

The hash values may be computed on the local computer system on which a resource is stored, and then sent to a repository at a pool server. A pool server is a data processing system within the network storing information (including hash values) relating to resources distributed across a plurality of data processing systems within the network. The comparisons can then be performed at the pool server on behalf of a number of connected computer systems, to determine which resources on which computer systems have matching hash values and so are replicas. The virus scan operation may be performed on the pool server for one of the replicas, and then the result of the virus scan can be communicated to a number of systems storing replicas of the resource. Furthermore, decontamination of an infected resource may be performed at the pool server, and a decontaminated version of the resource may then be communicated to other systems in the network. The virus checks and decontamination may be provided as a service of automated management of protection from computer viruses, and there may be a plurality of virus scanning programs and virus-decontaminator programs (potentially from different vendors) available for use with a single virus scan coordinator.

Performing an operation once on behalf of resources replicated across a number of systems may provide processing efficiency improvements, but may also enable a greater degree of automation and central control. Many modern enterprises are highly reliant on maintaining efficient computer operation, so the ability to automate and centrally manage operations such as virus checks could be a significant advantage. In particular, embodiments of the invention enable improved antivirus scanning efficiency. According to one embodiment, a snapshot can be taken of the virus-contamination state of files within a distributed system or LAN with less repetition of virus scanning than known approaches.

A further embodiment of the invention provides a method for controlling performance of an operation for a set of resources within a data processing network. The operation may be an analysis operation such as a virus scan operation, or a backup copy operation. Hash values are computed for a set of resources, and the computed hash values are compared with each other to identify resources having matching hash values. A required operation is performed in relation to a first resource, and a result of performing the operation is then recorded in association with the first resource and other resources identified as having hash values matching the hash value of the first resource.

Further embodiments of the invention provide a data processing apparatus comprising: a data processing unit; a data storage unit; a repository manager configured to store a set of hash values in at least one repository within the data storage unit; and a virus scan coordinator. The virus scan coordinator computes hash values for a set of resources, and compares the hash values of different resources to identify resources having matching hash values. The virus scan coordinator may then control the repository manager to record an indication in the repository that the result of performing the operation in relation to the first resource is to be relied on for resources having matching hash values. Subsequently (or alternatively), the virus scan coordinator may initiate performance of a virus scan for a resource and record a result of the virus scan for each resource having a matching hash value. The comparison of hash values may be performed in response to a requirement for a virus check, for example periodically or when initiated by a user action.

Alternative operational coordinators may also be provided, such as a backup copy coordinator for optimized backup of replica resources—enabling avoidance of unnecessary repetition of a slow data access operation associated with the backup operation—or a coordinator for determining and reporting on the distribution of resource instances.

A further embodiment of the invention provides a method for controlling scanning for computer viruses within a data processing network. Hash values are computed for each of a set of resources. In response to a requirement for a virus check, the computed hash values are compared with each other to identify resources having matching hash values. A virus scan is performed for a first resource. If the virus scan determines that the first resource is contaminated by a virus, a virus-contaminated status is recorded for the first resource and the identified resources having hash values matching the hash value of the first resource. If the first virus scan is performed on one data processing system within a network, whereas resources identified as being contaminated by virtue of their matching hash value are stored on other systems in the network, the present method may enable fast identification of some contaminated replica resources. However, the hash values will only match for viruses which make replicable changes to replica files, and this is not the case for polymorphic viruses.

Further embodiments of the invention provide computer programs for controlling the performance of any one of the methods described above, within a data processing apparatus or across a plurality of data processing systems in a network. The computer program may be made available as a program product comprising program code recorded on a machine-readable recording medium, or via an electronic transfer medium.

Further embodiments and advantages of the invention are described in the detailed description of embodiments below.

### BRIEF DESCRIPTION OF DRAWINGS

Embodiments of the invention are described in detail below, by way of example, with reference to the accompanying drawings in which:

FIG. 1 is a schematic representation of an example computer network, in which the present invention may be implemented;

FIG. 2 is a flow diagram showing some steps of a method according to an embodiment of the invention;

FIG. 3 is a flow diagram showing some steps of a method according to an embodiment of the invention;

FIG. 4 is a schematic representation of transmission of locally-generated hash values for a set of distributed resources to a pool server, and storing of the hash values in a central repository, according to an embodiment of the invention;

FIG. 5 is a schematic representation of a comparison between locally computed hash values and hash values stored in the central repository of FIG. 4;

FIG. 6 is a flow diagram showing the steps of a method according to an embodiment of the invention;

FIG. 7 is a flow diagram showing the steps of a method according to an alternative embodiment of the invention;

FIG. 8 is a flow diagram showing the steps of a method according to a further alternative embodiment of the invention; and

FIG. 9 is a flow diagram showing the steps of a method according to a further embodiment of the invention.

### DETAILED DESCRIPTION OF EMBODIMENTS

A first embodiment of the invention is described below in terms of a set of logical components of a data processing network, which cooperate to control of the performance of operations within the network to reduce duplication of processing. The logical components include computer programs executing on systems within the network, repositories within those systems, and resources such as programs and data files.

It will be apparent to a person skilled in the art that individual steps of the method described below can be implemented in computer program code and that a variety of programming languages and coding implementations may be used to implement the methods described herein. Moreover, the computer programs are not intended to be limited to the specific control flow described below, and one or more of the described steps of a program may be performed in parallel rather than sequentially as described. One or more of the operations described in the context of a computer-program-controlled implementation could alternatively be performed by a hardware electronics component.

Some portions of the following description refer to ‘algorithms’ for performing operations on data within a computer memory. An algorithm is conceived to be a self-consistent sequence of steps leading to a desired result. The steps are those requiring physical manipulations of physical quantities. Usually, these quantities take the form of electrical or magnetic signals capable of being stored, transferred, combined, compared, and otherwise manipulated. It is frequently convenient to refer to these signals as bits, values, elements, characters, numbers, or the like. It should be borne in mind, however, that the above and similar terms are to be associated with the appropriate physical quantities and are merely convenient labels applied to these quantities. Unless specifically stated otherwise, discussions within the present specification utilising terms such as “computing”, “calculating”, “determining”, “comparing”, “generating”, “selecting”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers, or other such information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and methods described below are not inherently related to any particular computer or other apparatus. Various general purpose machines may be used with programs in accordance with the teachings herein. Alternatively, the construction of more specialised apparatus to perform the required method steps may be appropriate.

In addition, the present specification also discloses a computer readable medium for storing a computer program for performing the operations of the methods. The computer readable medium is taken herein to include any transmission medium for communicating the computer program between a source and a destination. The transmission medium may include storage devices such as magnetic or optical disks, memory chips, or other storage devices suitable for interfacing with a general purpose computer. The transmission medium may also include a hard-wired medium such as exemplified by typical Internet-connected server computers, or a wireless medium such as exemplified in the GSM mobile telephone system.

Where steps or features in any of the accompanying drawings are referenced by the same reference numerals, those steps and/or features have the same or similar functions or operations in the context of the present description (unless the contrary intention appears).

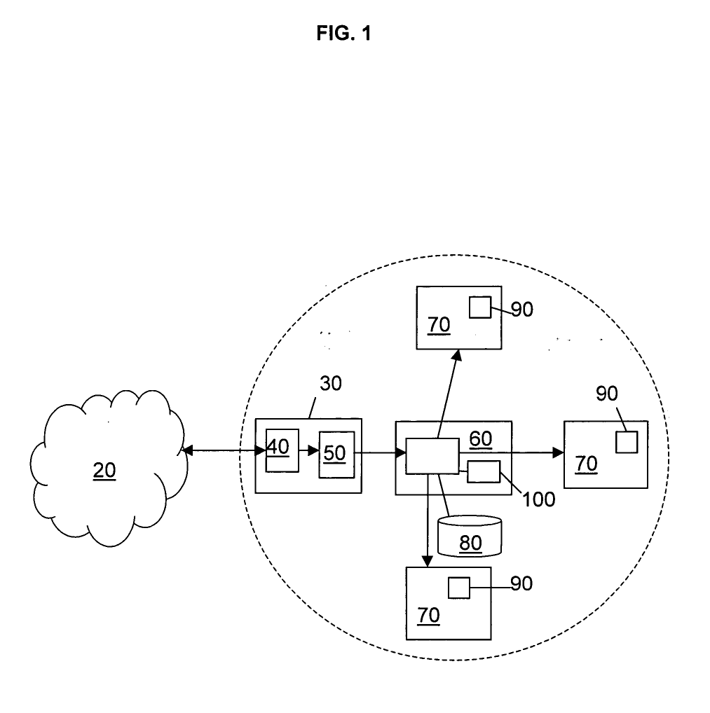

FIG. 1 shows an example local area network (LAN) 10 connected to a wider network 20 via a network gateway server 30. The network gateway server 30 is running firewall software 40 and routing software 50. A central server 60 is connected to the gateway server 30 and to a plurality of personal computers 70. At least the central server 60 has associated persistent storage 80. Embodiments of the invention have applicability within a single computer, such as one of the computers shown in the example network, in network applications for simple local area networks as shown, and in more complex networks.

A typical solution for virus protection in such a network includes antivirus software running as part of the firewall 40 on the network gateway server, for scanning incoming data such as e-mails. Antivirus software 90 is also installed and configured to run periodically on each computer of the network, and in response to user-generated commands. According to an embodiment of the present invention, the antivirus program 90 running on each personal computer 70 includes functions not provided by conventional antivirus programs. According to a distributed solution described below, a virus scan coordinator program 100 runs on the central server 60.

In a local area network environment, it is common for each personal computer 70 to have a similar set of installed computer programs, and for some of the data files stored within the LAN to be replicated across several computers in the network. Therefore, periodic executions of the antivirus software typically involve scanning identical data files and executable files on many different computers. The periodic virus scans involve scanning newly created and newly installed files, but also repeating virus scans of files which were already in existence when the last virus scan was performed. The pre-existing files may not have changed since the last scan, but repeated scanning of pre-existing files has previously been considered essential for protection because timestamps on files cannot be relied on as evidence that the files have not changed.

The inventors of the present invention have identified these issues as problems requiring a solution. Embodiments of the invention described below use a comparison of hash values computed from the bit patterns representing stored files to identify which files have changed since the last virus scan. The embodiment avoids full virus scanning of files which have not changed since the last scan. Another feature, or alternative embodiment, of the invention also uses a comparison of hash values to identify replicas of files to avoid repetitious virus scanning of multiple replicas. Further embodiments are described thereafter.

A number of hashing algorithms are known for use in cryptographic solutions—such as digital signature applications where a large file must be compressed in a secure manner before being encrypted. An example is the MD5 Message-Digest algorithm as described in the Internet Engineering Task Force Network Working Group's Request for Comments 1321, “The MD5 Message-Digest Algorithm”, R. Rivest, April 1992. MD5 produces a 128-bit hash or digest of an input of arbitrary length—providing security in the sense that it has been considered ‘computationally infeasible’ to produce two messages with the message digest, or to compute a message having a pre-specified target message digest. This does not mean that the MD5 algorithm is totally unbreakable, and a more secure algorithm is preferred for implementing the present invention.

The Secure Hash Algorithm (SHA) is another hash function, specified in the Secure Hash Standard (SHS, FIPS 180) and revised in 1994 to produce SHA-1. SHA-1 is described in the IETF Network Working Group's RFC 3174, “US Secure Hash Algorithm 1 (SHA1)”, D. Eastlake 3^{rd} and P. Jones, September 2001. SHA-1 takes a message of less than 2⁶⁴ bits in length and produces a 160-bit message digest. SHA-1 is slightly slower but more secure than MD5.

Other hash functions are also known, including a number which are currently considered ‘secure’ which have output hashes of 160 to 512 bits, such as RIPEMD-160 (a 160-bit cryptographic hash function, designed by Hans Dobbertin, Antoon Bosselaers and Bart Preneel) and WHIRLPOOL (a hash function designed by Vincent Rijmen and Paulo Barreto which operates on messages less than 2²⁵⁶ bits in length, and produces a message digest of 512 bits).

The level of security of a hash, as determined by the number of output bits and the hashing algorithm, indicates the strength of its non-collision property. The specific hash algorithms mentioned above are for illustrative purposes only. The choice of a specific hash function can be made according to the computing power available at implementation or deployment time, and other characteristics of the hardware and software environment, to ensure an optimum balance between security and speed. A suitable hash function H is a hash function which satisfies the non-collision property such that it is computationally infeasible, at the time of deployment, to find a message y not equal to a message x such that H(x)=H(y). The SHA-1 algorithm, which produces message digests having 160 bits and is (at the time of writing) considered appropriate for many digital signature applications, is an example of an algorithm which is appropriate (at the time of writing). In general, hashes of a length considered appropriate for digital signature applications at a particular point in time will also be appropriate for implementing the present invention at that point in time.

Secure hashes (such as those generated using SHA-1) are ‘computationally unique’ for a specific bit pattern. This means that the likelihood of two identical hash values arising from hashing two different files—referred to as a ‘collision’ between hashes—is very low. Techniques described below exploit this ‘uniqueness’ property of the secure hashes to determine whether a file has been modified in the period between the previous virus scan and the present virus scan. If the file has been modified, a hash value computed after the change will differ from a hash value computed before the change, and this difference determines that another virus scan is required. If the hash value matches, the file is assumed not to have changed, and so the previous virus scan result is relied on. In this way, secure hashes computed for each of a set of files are used to identify the files that have to be scanned in a virus scan.

Also described are techniques which enable a reduction of virus scanning of replica resources (for example, duplicates in backup storage, or multiple replicas distributed across a network). Matches between secure hashes are used to identify replica resources and the result of a virus scan of a resource is used in relation to one or more replicas of the resource. Also disclosed are techniques for identifying data processing systems within a network which have vulnerabilities to virus attacks, using secure hash values as identifiers of resources known to be associated with such vulnerabilities.

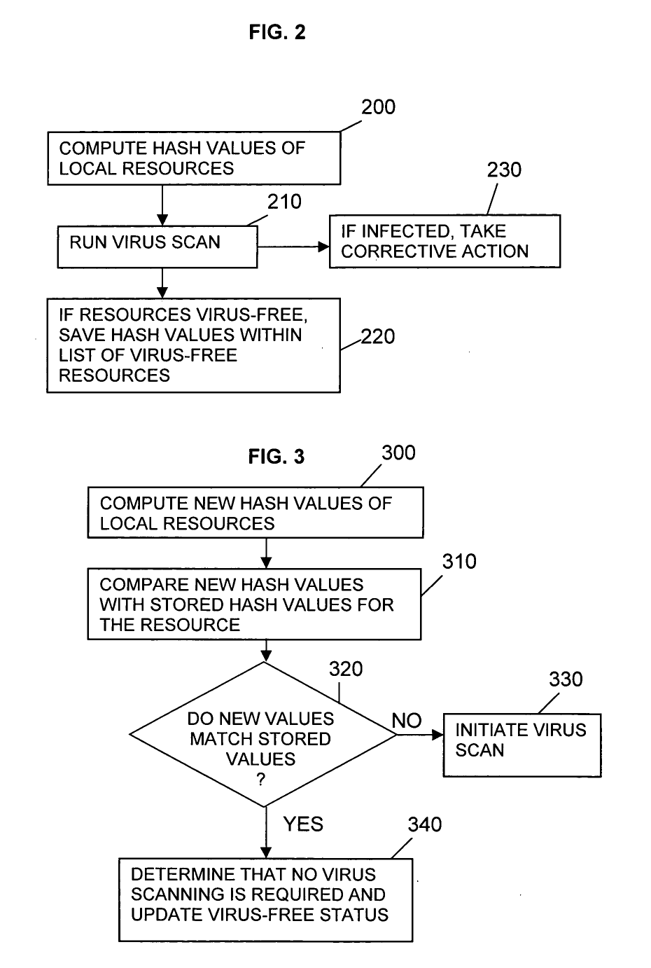

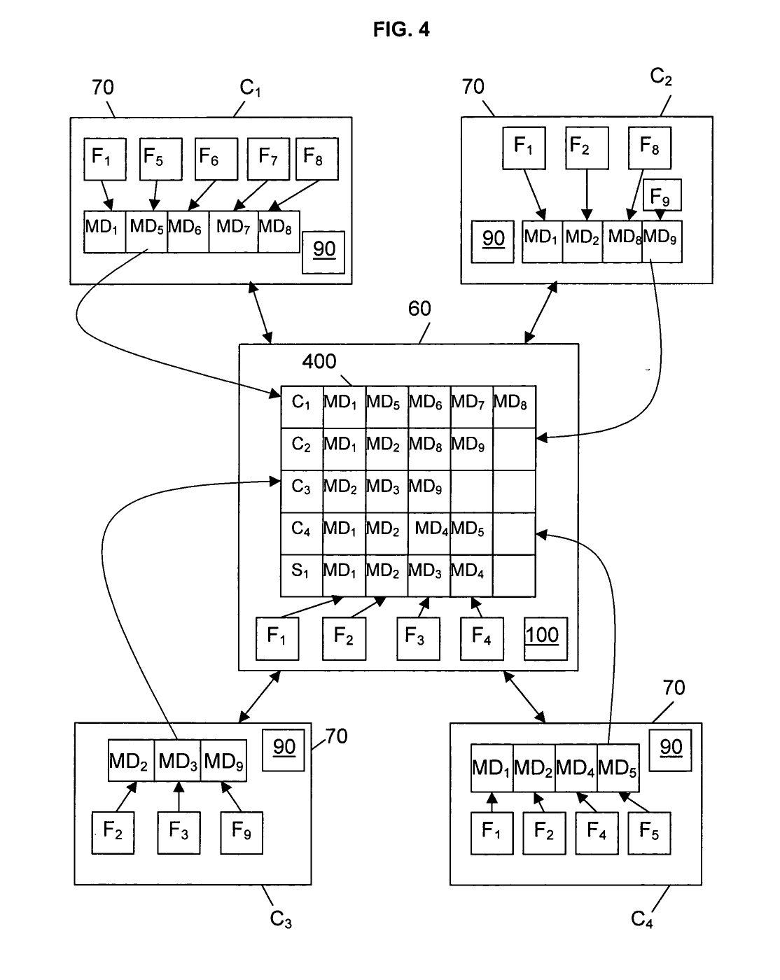

A method according to one embodiment of the invention is summarized in the schematic flow diagrams of FIGS. 2 and 3. A more detailed description of an embodiment of the invention is provided with reference to FIGS. 4, 5 and 6.

Referring to FIGS. 1 and 2, an initial execution 210 of an antivirus program 90 running on a data processing system 70 within a local area network 10 may scan all of the local system's files for computer viruses, or may scan a subset of files specified by a user. A periodic virus check of all files may be required by the user's employer. The local antivirus program 90 also invokes a message digest function (which may be an integral module of the antivirus program 90) to compute 200 hash values for resources of the system 70. A system's resources include the data files and executable files stored on the system. The message digest function is applied to a bit pattern of each potentially injectable file, to each new file and to any file having a last-modification timestamp which differs from the timestamp of the last virus check.

If the resources are found to be virus-free, this fact is recorded 220 together with the computed hash values. Thus, a list of hash values is generated for resources classified as virus-free, and this list is stored on the local system. In one embodiment of the invention (described in detail below with reference to FIGS. 4, 5 and 6), the generated list of hash values for the virus-free resources of each system in the LAN is sent to a repository 80 on a pool server 60. The pool server provides storage facilities for storing information relating to resources on all of the systems within the LAN, including the list of hash values for resources identified as virus-free and copies of selected resources of the different systems.

If infected resources are identified, action is taken 230 to isolate (“quarantine”) the virus and actions may also be taken to decontaminate or remove the infected resource. The quarantining and decontamination steps may use known virus-protection techniques at each system, or alternatively decontamination steps may be performed at the pool server on behalf of a number of systems in the network and a copy of the decontaminated version of the resource may be sent to the other systems.

Subsequently, as shown in FIG. 3, new hash values are computed 300 when a virus check is required—either periodically or when triggered by user actions. The periodicity of scheduled virus checks is determined by settings of the antivirus program 90 running on the local system 70. The new computed hash values are compared 310 with the stored hash values and a determination is made 320 regarding whether the new hash values match the respective stored hash values. A match between respective new and stored hash values indicates that the respective resources have not changed since the last scan 210 determined that the resources were virus-free. Resources for which the stored and newly computed hash values match can be assumed to be virus-free—because virus contamination (or any other change) would have resulted in a different hash value being computed. Identification of a match between respective stored and new hash values leads to a determination 340 that no virus scanning is currently required for the relevant resource, and the virus-free status of the resource is updated by adding a new timestamp.

However, any difference between the stored and new hash values implies that earlier virus scan results cannot be relied upon. Therefore, a virus scan is initiated 330 for any new resource (any resource which did not exist when the last virus scan was carried out) and any other resource which does not have matching old and new hash values. If the virus scan finds that a new resource is virus-free, the new hash value is stored in a list of virus-free resources.

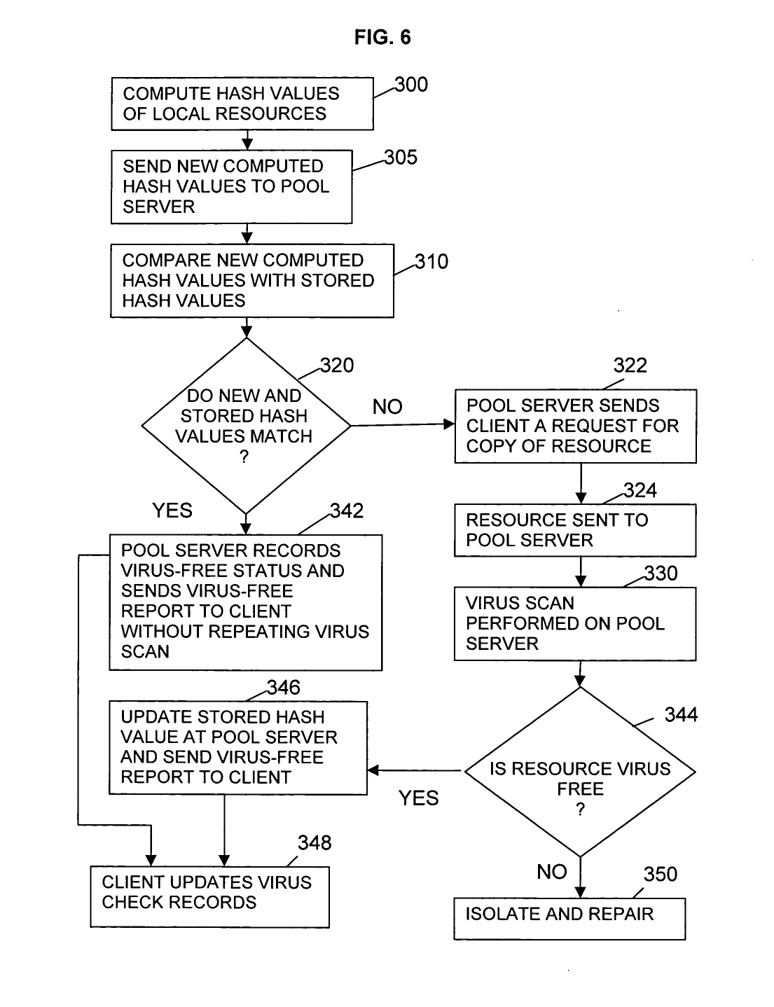

Referring to FIGS. 4 and 6, a distributed architecture according to one embodiment of the invention comprises a pool server data processing system 60, which includes one or more repositories 400 storing data on behalf of the local server itself and on behalf of the other data processing systems 70 in the local area network 10. In particular, the pool server's repositories 400 store hash values for files stored on each of the data processing systems within the LAN which files have been classified as virus-free. In a simple LAN, such as shown in FIG. 1, the pool server system may be a central server 60 or any one of the systems in the LAN which is capable of maintaining the repository 400 and running virus scan coordinator software 100. Of course, a more complex LAN may comprise tens or hundreds of interconnected computer systems and may form part of a wider network (a WAN, intranet or the Internet).

FIG. 4 is a schematic figure showing a number of files F₁, F₂, . . . F₉ distributed across a number of data processing systems within a LAN 10. Many of the files have replicas elsewhere in the LAN—for example, file F₁ is replicated on each of systems C₁, C₂, C₄ (70) and S₁ (60), but not C₃ in this example.

An antivirus program (either a client antivirus program 90 or a virus-scan coordinator 100) runs on each system 70,60 within the LAN 10. The antivirus programs 90,100 each include a message digest function (for example, a function implementing the SHA-1 algorithm). For each data file or executable file for which virus scanning is applicable, the message digest function running on the local system 60, 70 is used to compute 200 a Message Digest (hash value) MD₁, MD₂, . . . MD₉, where MD(F_{N})=MD_{N}.

In a particular embodiment, hash values are computed for only a subset of files on the system, comprising the file types which can contain executable components. Such files include .exe, .com, .dll, nsf, zip, cab, .lwp and .doc files (since .doc files can contain macros). Although file name extensions cannot be relied upon as evidence of a file type, a file having a name extension indicating a non-executable file type is generally not independently executable without renaming. That is, although virulent code could rename a file falsely named as a non-executable ‘.txt’ file (for example) and execute any viral contents, a virus within the ‘.txt’ file should not be independently executable. Therefore, protection against viruses which could invoke viruses embedded in nominally non-executable files may provide adequate protection—at least for some virus checks.

Thus, recomputing of hash values may optionally be omitted for file types which do not contain executable code, for some virus checks. The invention may be implemented to allow file type selection for selective computation of hash values for some virus checks, but to require computation of hash values for all files for other checks. The determination of whether selection is permitted or not may be made according to the current system workload, or which operations are running in the system or according to how the virus check was initiated.

For example, files F₁, F₅, F₆, F₇ and F₈ are stored (held in volatile memory or persistent disk storage) on system C₁. The message digest function computes 200 respective hash values for each file—MD₁, MD₅, MD₆, MD₇ and MD₈. Similarly, files F₁, F₂, F₃ and F₄ are stored on system S₁ (60) and the locally executing message digest function computes 200 respective hash values MD₁, MD₂, MD₃ and MD₄. The antivirus program 90, 100 executes 210 to determine whether the locally-stored files are virus-free. If files are determined to be infected by a virus, corrective action is taken 230 in accordance with known isolation and decontamination techniques.

If the scanned resources are classified virus-free, the local antivirus program 90, 100 transmits the corresponding hash values MD₁, . . . , MD_{N} to the repository 400 on the pool server system S₁ (60). Data transmission between a personal computer 70 and the pool server 60 takes place over a secure channel, which may implement Secure Sockets Layer (SSL) security for example. In the case of client antivirus programs 90 executing on the personal computers 70, the local antivirus programs 90 send their hash values to the virus scan coordinator program 100 running on the central server 60, and the virus scan coordinator 100 updates 220 the repository 400.

After the steps described above (and summarized by steps 200-220 in FIG. 2) have been carried out for each system in the network, each system holds a set of hash values associated with the locally stored set of resources which potentially require virus scanning. As shown in FIG. 4, the repository 400 on the pool server 60 includes hash values for all of the resources on systems within the LAN that potentially require virus scanning. The repository 400 may also store an indication of the contamination state of each resource (such as ‘virus-free’, ‘contaminated’, or ‘virus-check expired’). Let us assume that, at a certain point in time, all of the resources on each system in the LAN have been classified virus-free. The stored hash values can then be used to improve resource usage during subsequent executions of the virus scanning programs, as described below.

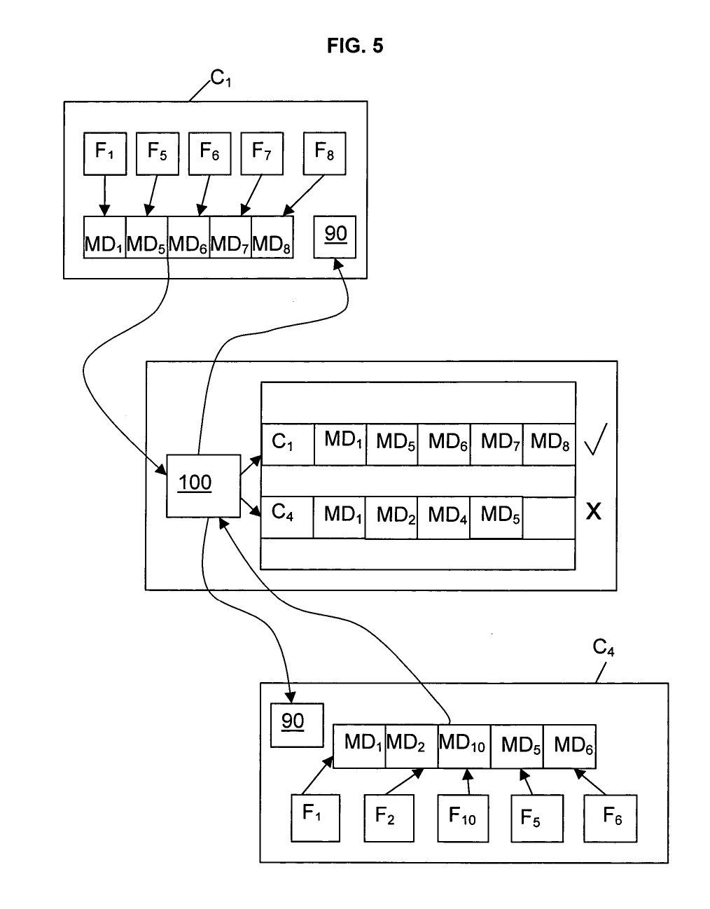

FIG. 6 is a flow diagram showing a sequence of steps performed during cooperation between one of the personal computers 70 and the pool server 60. By way of example only, the steps are described with particular reference to systems C₁ and C₄ of FIGS. 4 and 5.

Upon expiry of a predefined time interval for virus scans or when initiated by user actions, the message digest function of the antivirus program 90 running on system C₁ computes 300 a new set of hash values MD₁, MD₅, MD₆, MD₇ and MD₈ for the set of installed files F₁, F₅, F₆, F₇ and F₈. The antivirus program 90 on system C₁ sends 305 the new set of hash values to the virus scan coordinator program 100 running on the pool server 60. The virus scan coordinator program 100 on the pool server identifies the set of hash values held in the repository 400 for system C₁, and compares 310 the stored set of values with the newly computed set of values for C₁. The comparisons determine 320 whether each of the newly computed set of hash values matches a hash value stored in the repository 400 for system C₁.

If the determination 320 has a positive result for the entire set of hash values for system C₁, the virus scan coordinator program 100 running on the pool server S₁ updates the repository 400 by saving an updated timestamp in association with the existing record of the virus-free status of the files on system C₁. The virus scan coordinator program 100 sends 342 a report to the system C₁ indicating that the set of files on the system C₁ are virus-free. The client antivirus program 90 running on the system C₁ also records 348 a timestamp for the current virus check. This updating of timestamps is not essential to all embodiments of the invention, since hash values may be computed, stored and compared without reference to timestamps.

Thus, the determination that no files have changed since the previous virus scan, together with the previous determination that all files are virus free, has been used to determine that no files currently require virus scanning. In this example, a virus check has been performed without execution of a full virus scan for any resources.

Similarly, the message digest function of the client antivirus program 90 running on system C₄ computes 300 a new set of hash values MD₁, MD₂, MD₁₀, MD₅ and MD₆. Of the set of files stored on system C₄, files F₁, F₂ and F₅ are unchanged since the last virus scan, and so their hash values (MD₁, MD₂ and MD₅) are also unchanged. However, since the last virus scan, a new file F₆ has been added and file F₄ has been modified to create file F₁₀, resulting in new hash values MD₆ and MD₁₀. The client antivirus program 90 running on system C₄ sends 305 the new set of hash values to the virus scan coordinator program 100 on the pool server 60. The virus scan coordinator program 100 identifies the relevant set of stored hash values (MD₁, MD₂, MD₄, MD₅) for system C₄ in the repository 400 and performs a comparison 310 with the received new hash values. The comparison determines 320 that there is a mismatch between some of the newly computed hash values and those stored in the repository 400 at the pool server 60.

In response to the identification of a mismatch, the virus scan coordinator program 100 running on the pool server sends 322 a request via the client antivirus program 90 running on the system C₄ for a copy of the resources corresponding to the non-matching hash values MD₆ and MD₁₀. The receiving client antivirus program 90 uses the hash values MD₆ and MD₁₀ as pointers to identify files F₆ and F₁₀, and sends 324 the files F₆ and F₁₀ to the virus scan coordinator program 100. The virus scan coordinator program 100 executes 330 its virus scanning functions on the pool server 60 to determine 344 whether the files F₆ and F₁₀ are contaminated or virus-free.

If any files are contaminated, virus-protection functions such as quaratining or decontaminating are performed 350, initially on the pool server. The coordinator program also alerts the client antivirus program 90 running on system C₄ that specific files have been found to be contaminated, and either provides a copy of a decontaminated version of files F₆ and F₁₀ or prompts the client antivirus program 90 on system C₄ to perform 350 quarantining or decontamination. If all files are determined 344 to be virus-free, the virus scan coordinator program 100 updates the repository 400 by replacing the previous set of hash values MD₁, MD₂, MD₄ and MD₅ with the newly computed set of hash values MD₁, MD₂, MD₁₀, MD₅ and MD₆, and recording 346 the virus-free status of the files corresponding to these hash values. The coordinator program then sends a virus-free status report to the system C₄ and the locally-executing client antivirus program 90 also records 348 the virus-free status of the resources stored on system C₄.

Note that a full virus check has been performed for system C₄ without scanning the majority of the files on the system. Although the proportion of files requiring a virus scan will depend on the proportion of files which are new or have been modified since the last virus check, only a small subset of files on a system are typically added or modified between consecutive virus checks and so a typical virus scan can be limited to a subset of files.

The above-described method can be implemented with an additional feature for identifying replicas of files using comparison of hash values. By avoiding virus scanning of multiple replica files, repetition of virus scanning can be reduced.

Note that the repository 400 shown schematically in FIG. 4 includes hash values for the set of resources of a plurality of different data processing systems within the LAN. The set of hash values of different systems are compared to identify replication of files between the different systems. As noted above, and referring to steps 342 and 346 of FIG. 6, the virus scan coordinator program 100 sends a virus-free status report to the system for which the virus check was required. When the replica-identification feature is implemented, the coordinator also sends the virus-free status report to any other systems within the plurality of data processing systems which hold a copy of resources determined to be virus-free (by steps 310,320 or steps 330,344). This identification of replicas is described below in more detail.

Virus-contamination-status reports (including hash values, an indication of the contamination status, and optionally other metadata) may be encrypted before being sent from the pool server to client data processing systems. Conventional cryptographic techniques may be used. A further computation of hash values for local resources (and comparison with the hash values within the virus-contamination reports) may be performed at each client data processing system before recording a virus-free status for each resource. Such checks at the client system ensure that a virus check which was based on out-of-date hash values stored in the pool server, is only relied on to update the local virus-contamination status information if the resources are still identical to those stored at the pool server.

For those files with hashes that are not certified virus-free, the virus scan coordinator program 100 runs on the pool-server to scan the files for computer viruses and, in some cases, to take corrective action. The subset of files which require virus scanning, and which are not already stored on the pool server, may be transferred to the pool-server 60 following a determination that scanning is required for that subset. The files are then scanned for viruses, and the result of the scan is reported to at least those systems holding one or more of the subset of files. A decontaminated version of a file may be generated by the antivirus program 100 on the pool server and then forwarded to at least those systems holding one or more of the subset of files requiring a scan.

Thus, a method of checking for computer viruses can be implemented such that a full antivirus scan executes only once for each file unless the file is changed, even if a copy of the file is present on multiple data processing systems. The antivirus program can also run on the individual system, such as in case of an emergency, at a user's request, or in response to an update to virus definitions.

As mentioned above, a virus checking method according to one embodiment of the invention identifies and takes account of the replication of files within the network to avoid virus-scanning identical files on every individual data processing system. This feature can be implemented as an additional feature, which complements the above-described comparison of hash values to identify files which have not changed.

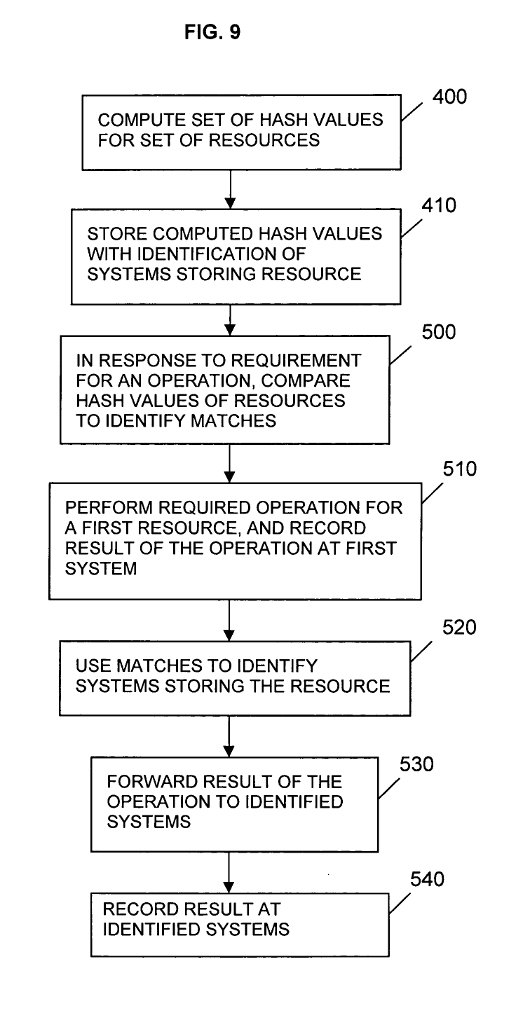

However, in alternative embodiments of the invention, the feature of identifying replicas by comparison of hash values may be implemented independently of the feature of identifying unchanged files by comparison of hash values. Furthermore, the feature of using secure hash values to identify replicas may be applied to reduce repetition of operations other than virus scanning. FIG. 9 shows a sequence of steps of a method for identifying replicas and avoiding repetitive performance of a specified operation for replicas of a resource. Periodically, or in response to a requirement for performance of a specified operation, systems within a LAN or network region (referred to hereafter as ‘the LAN’ for simplicity) compute 400 a set of hash values for resources stored on the respective systems. A secure hash function is applied to a bit pattern representing each resource for which a hash value is required. Each system then sends the computed hash values for locally stored resources to a pool server within the LAN. A coordinator program running on the pool server controls a repository manager to update 410 a repository of hash values representing a set of resources distributed across a plurality of systems within the LAN. The repository holds the hash value for each resource and an identification of the system on which the resource is stored.

A specified operation may be invoked by a user request or by expiry of a timer controlling periodic performance of the operation. The operation may be a virus scan performed at an end-user system within the LAN, or performed at the pool server. The operation may be a backup copy operation, or a combination of backup and virus check using a single read of a resource from secondary storage. When the specified operation is invoked at one of the systems within the LAN, a check is performed 500 of the hash values stored at the pool server. The check identifies replicas of resources within an individual system or distributed across the plurality of systems in the LAN, by identifying matches between hash values stored for different resource instances. A match between two hash values derived from applying a secure hash function to each resource's bit pattern demonstrates that the resource instances are identical replicas, since secure hash values are unique representations of the resource instance. The coordinator program retrieves 520 from the repository an identification of the systems within the LAN which hold replicas of a resource. When the specified operation is performed 510 in relation to a resource, a result of performing the operation is recorded at the system which performed the operation. The result is also sent 530 to each of the identified systems holding replicas of the resource. The result of the operation is then stored 540 at the identified systems. Such a method enables records to be updated at a plurality of systems within a LAN in response to performing the operation once in relation to one of the replicas of the resource within the LAN, and relying on matching hash values to identify replicas of the resource for which the same result can be recorded without repetition of the operation.

For example, a virus scan may be performed at the pool server or one of the other systems within the LAN, and the result of the virus scan may then be communicated to other systems in the LAN without repeating the virus scan for every replica of the resource. Where the set of resources include executable files which have a replica on every system in the network, or the resources include compressed groups of executable files and/or data files, the ability to avoid unnecessary repetition of the operation may provide efficiency and performance improvements. As a second example, a backup copy of a resource may be stored at the pool server and the plurality of systems holding copies of the resource may receive a confirmation that the backup has been performed at a particular time—avoiding the need for multiple replica backups on each system.

The previously-described hash value computation and comparison by a coordinator program may be used to query and report on the distribution of replicas of resources over a network. For example, there may be a requirement to track distribution of copies of a confidential document or to track distribution of copies of a resource for which licence fees are payable. The previously described repository of hash values (and identifiers of relevant systems) is supplemented by information regarding authorisation levels or the organizational hierarchy of users within an organisation, and an identifier of responsible users of particular data processing systems. By way of example, the following describes an example solution in which a person such as a security auditor or program licensor wishes to know the set of users who (or computers which) have copies of a resource. The person sends a request to a distribution reporting coordinator. For example, a user Shiva wishes to know all users who have copies of a specified confidential document, or users of a trial version of an executable program. The distribution reporting coordinator computes a hash value for the specified document or executable program, and compares the computed hash value with hash values stored in a repository representing a set of resources distributed across a plurality of data processing systems in a network. The distribution reporting coordinator then checks whether Shiva is authorised to see a list of other users. This authorisation check may be based on an access control list related to the organisational hierarchy within which Shiva works. In another embodiment, each identified user storing a replica of the resource is sent a request for approval to show Shiva the list of users or systems holding copies of the resource. (This request may be escalated within the organisation if some users decline. The escalation hierarchy may differ from the organisational hierarchy.)

If Shiva determines that a user who has a copy of the resource should not have a copy, Shiva and the unauthorised user may negotiate a resolution (such as payment of a licence fee or deletion of unnecessary replicas of a confidential document), or Shiva may send an alert message to a higher authority. Additional controls may be implemented, such as to set a threshold for the number of resource distribution queries that users can submit in a time period. The threshold may be dependent on the user's position in the organisational hierarchy.

Another alternative to the embodiments described in detail above applies the methods of hash value computation and comparison to determine which resources have not changed and so do not currently require a backup copy operation. A comparison of hash values is performed to determine which files are unchanged and can therefore be skipped in the current backup. The hash value computation and comparison (“snapshot”) process can be configured to run periodically or a user can initiate the process. Data from all the computation and comparison snapshots across the network can then be integrated to a unified network-wide view of stored resources and their virus-contamination status.

Described above is a distributed client-server approach to detection of and possible corrective action against viruses, which can be used to reduce data transmission and reduce duplication of virus scanning within a computer or network. This can increase the efficiency of antivirus processing compared with typical known techniques. According to one embodiment, the antivirus program on the client system schedules the hash value computation process on the client system. On a cooperating server system, a new hash value (MD) computed by the message digest function triggers scanning of the corresponding file for any viruses, using the latest virus definition files. If the scan determines that a file is free of known viruses, the antivirus program running on the server classifies the file and the associated hash value (MD) to be virus-free. The antivirus program adds the new hash value (MD) to the list of virus-free hash values. If the same hash value is received from another computer system, the antivirus program running on the server is able to certify the corresponding file and hash value to be virus free without repetition of the virus scan.

If a virus scan determines that a file is infected by a virus, the hash value (MD) for that file is classified as infected and a notification of the infected state is sent to the system on which the file is stored. The user can take suitable corrective actions, such as is known in the art, or the antivirus program running on the server may disinfect the file and provide the disinfected version of the file to the user's system.

When new virus definition files are added into the antivirus programs, the list of files whose hash values have previously been classified virus-free can be rescanned using the new virus definitions, for example as a background process during periods of relatively low processing activity. This process should identify files infected before the relevant virus definition was known. If the result of the rescanning is that some files previously classified as virus-free are now reclassified as infected, the virus scan coordinator program running on the server sends the list of infected files to at least the systems holding copies of those files.

If a virus was known to have been created after a file was virus-scanned and classified as virus free, an identification of matching hash values could still confirm that the file is not contaminated by that virus. This statement is true even if the initial virus scan was incapable of recognizing the new virus. Since the virus could not have contaminated the file before the virus existed, the original hash value represents a resource which could not have been infected by that virus at that time. However, because of the difficulty determining the date of creation of a virus, one embodiment of the invention re-scans each resource each time new virus definitions become available. Described in the following paragraphs is an alternative to re-scanning all files as soon as new virus definitions become available. The alternative includes prioritizing re-scanning according to the likelihood of infection by a previously undetected virus.

Periodically, hashes of the files on client data processing systems are reported to the pool server. The pool server records the information about the source of the hash and the time at which it was found to exist. Antivirus scanning is performed for all files corresponding to newly discovered hashes that do not already exist in the pool server's repository of hashes. The scanning may be performed either on the pool server or on the client data processing system at which the resource is stored. However, those hashes that were at least twice observed on the network and found to be virus-free in all previous virus scans are treated in a special way. The hash value corresponding to a resource is time-stamped when a virus scan is performed—this applies to all resources. If the difference (T2−T1) between the earliest and latest timestamps (T1 and T2) of virus scans of a resource exceeds a certain threshold (which may be a user-configurable parameter) and the hash value of the resource is unchanged since T1, the resource is classified a low priority resource for virus scanning. The threshold period must be sufficient that there is only a low likelihood that a virus could have existed at time T1 and yet remained undetected by virus scans up to and including the scan at time T2.

If virus definitions are changed, the low priority resources are not re-scanned immediately but instead their re-scanning is deferred until a period of very low system activity. In some cases, the resources may be excluded from the requirement for a virus scan and confirmed as ‘virus free’ without applying the new virus definitions, on the basis that the likelihood of infection prior to T1 is very low for a given time difference (T2−T1).

The current antivirus scan, which is performed due to the availability of new virus definitions, is therefore applied to any new bit patterns found within the network and other resources not classified as low priority, since these resources are far more likely to contain viruses than those classified as low priority. If the files classified as low priority for virus scanning are scanned later, when system usage is low, any virus which is identifiable using the new virus definitions will eventually be identified.

Typically, a large percentage of all the files on the network would be classified as low priority for virus scanning, and so the deferral of re-scanning may provide a significant optimization. The deferral may defer identification of viruses which existed at time T1 and were undetected by time T2, but this risk may be considered acceptable if the deferral of virus scanning for some resources enables more efficient use of processing cycles. This is explained below. Since the match between hash values confirms that no virus infection has occurred since time T1, and no virus was detected in the scan performed at time T2, the only possible virus infections are viruses which infected the resource before time T1 and yet remained undetected at time T2. For at least the viruses which replicate themselves efficiently, the probability of the virus remaining undetected decreases very quickly over time. Therefore, the proportion of viruses which could have existed at time T1 and yet remained undetectable by antivirus programs until time T2 can be assumed to be very small for a suitably large period (T2−T1). Since the probability of a virus infection is therefore very low given matching hash values and a suitable large period (T2−T1), rescanning in response to new virus definitions can be deferred until a convenient time at relatively low risk.

In the embodiments described in detail above, a local antivirus program 90, 100 performs an initial virus scan for resources running on the local system, whereas subsequent virus scans may be performed on the pool server or on each system in the network as required. In an alternative embodiment, all virus scanning including the initial scan is performed at the pool server under the control of the virus scan coordinator program 100. In the latter case, the client antivirus program 90 running on other systems in the network performs the computation of hash values and communicates with the virus scan coordinator program 100 on the pool server. Decontamination actions may be performed on the pool server or at each system as required.

A further embodiment of the invention enables prioritization of virus checking for different resources within the network, for processing optimization and to focus virus scans where risks are highest, as described below.

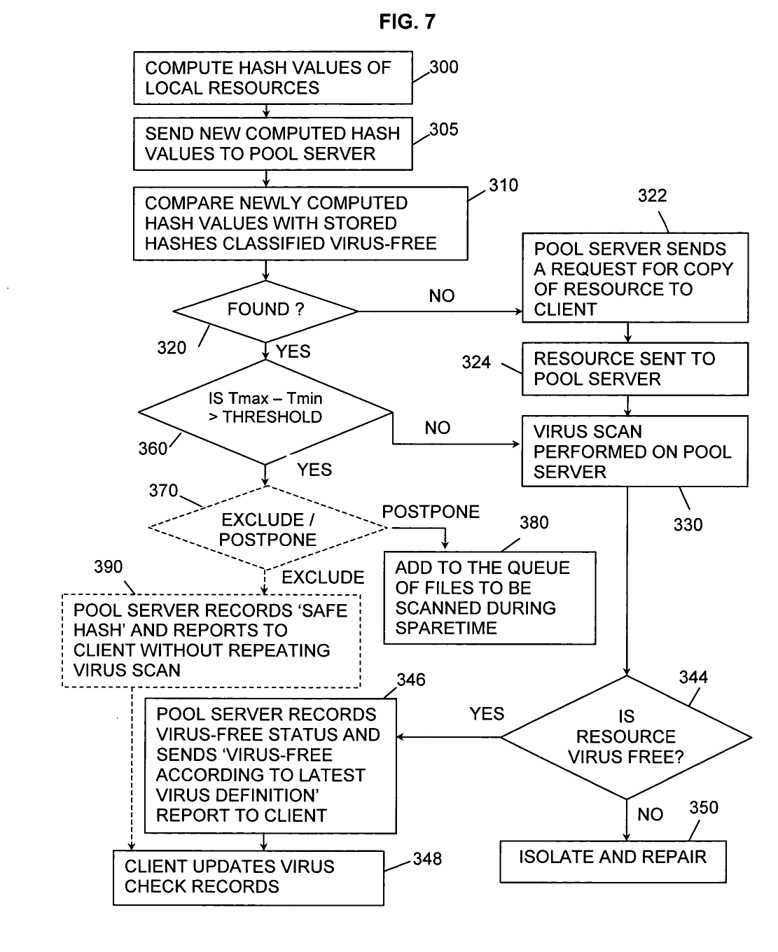

FIG. 7 shows an embodiment of the invention in which virus scanning is employed on the pool server for the following set of resources: resources which do not have hash values in the pool server; and resources which do have a hash value within the pool server but have not been classified a low priority for virus scanning. However, virus scanning is deferred for resources classified as low priority, or the resources are excluded from the requirement for a virus scan. Consistent with the embodiment shown in FIG. 6, hash values are computed 300 at a data processing system for locally stored resources, and the computed hash values are sent 305 to the pool server. The repository 400 on the pool server is searched 310 for matches between the newly computed hash values and stored hashes representing resources previously classified as virus-free. If no matching hash value is found 320 within the stored ‘virus-free’ hash values, the method proceeds as shown in FIG. 6. That is, the pool server sends 322 a request for a copy of the resource to the client data processing system which holds the resource. The resource is sent 324 to the pool server and a virus scan is performed 330 on the pool server. If the scan determines 344 that the resource is virus-free, the pool server updates 346 its records and sends 346 a ‘virus free’ report to the client data processing system at which the resource is stored. This report is an indication that the resource is classified virus-free according to the latest virus definitions used in the scan. The client system then updates its virus check records.

However, according to the embodiment of FIG. 7, a positive match between newly computed and stored hash values does not necessarily result in the resource corresponding to the matched hash values being declared virus-free. Firstly, a check is performed 360 of the timestamps associated with the previous virus scans of the resource. These timestamps are held together with the hash values in the repository at the pool server. If the time period between the earliest and most recent virus scans of a resource (that is, the difference between time Tmin and Tmax) exceeds a threshold, the resource is considered a low priority resource for virus scanning. In one implementation (A), an identifier of each low priority resource is added 380 to a queue of resources to be scanned during spare processor cycles when use of the computer system is low. In another implementation (B), all low priority resources are simply excluded from the current requirement for a virus scan, and the pool server records 390 a virus-free status without repeating a virus scan. In a third implementation (C), a determination 370 is made regarding whether to exclude or postpone virus scanning for a low priority resource. The determination 370 may be based on the type of resources or on the type of event which initiated the current virus check (timer expiry or user initiation). The choice between the three optional implementations (A,B,C) of this embodiment is made according to the level of protection from viruses required for the network.

A further embodiment of the invention enables identification of vulnerability to virus attacks. Currently, many organizations notify computer users within the organization of vulnerabilities associated with particular computer programs. The user is required to follow a first set of instructions to manually check which version of a program is installed on their system, and a second complex set of instructions to resolve the vulnerability. This known approach to managing vulnerabilities to virus attack is unreliable, since users may delay or ignore the instructions to remove a vulnerability. Additionally, modern businesses cannot afford the management time involved in coordinating such a resolution process throughout the organisation.

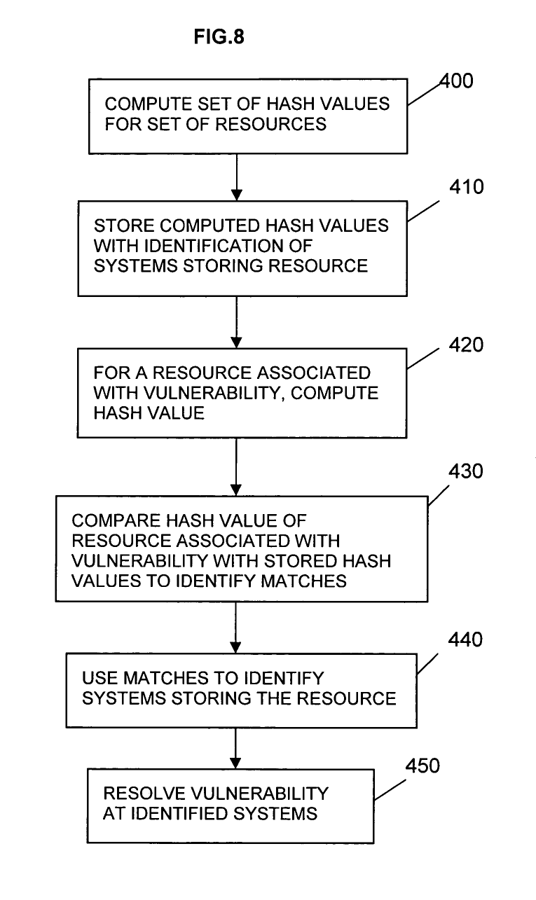

In some cases, a vulnerability arises due to the presence of a particular resource—such as particular versions of a computer program—or is recognizable from the presence of certain files. A secure hash value can be used as a convenient identifier which uniquely and consistently represents such files. Referring to FIG. 8, and similar to the methods described above, hash values may be computed 400 for resources of a plurality of data processing systems in a network and then stored 410 in a repository at a connected server data processing system. According to the method of FIG. 8, if a vulnerability to viruses is identified for a particular resource, a hash value is computed 420 for the resource associated with the vulnerability. The hash values in the repository are compared 430 with the computed hash value for the ‘vulnerable’ resource to identify matches. Matching hash values indicate 440 replicas of the ‘vulnerable’ resource, and so can be used to test for replicas at any of the data processing systems within the network for which the repository holds hash values. Having identified the vulnerable systems which include the resource, action can be taken 450 at each system to remove the vulnerability.

For example, version 1 and version 2 of a program may include the vulnerability, whereas the vulnerability is removed when developing version 3. Hash values are generated 420 by applying a secure hash function to the respective bit patterns of version 1 and version 2. The repository of hash values is then searched 430 for hash values matching the hash values generated for versions 1 and 2 of the program, to identify 440 systems within the network at which copies of version 1 or version 2 of the program are installed. Version 3 of the software can then be automatically sent to the identified systems to replace 450 the vulnerable versions, or a user can be sent a vulnerability report prompting user action to resolve 450 the vulnerability.

For antivirus and backup applications of the message digest function, the computation of hash values may be scheduled to execute periodically for a system, such as once per week. Frequently used and important files on the system may be monitored more frequently, by configuring the message digest function to run for a subset of files at specific times or when processor usage is low. For example, a timer determining expiry of a defined inactivity period may trigger execution of the message digest function at the same time as triggering display of a screen saver. Additionally, the message digest function may be initiated by user inputs, and a graphical user interface may be modified to provide a selection point (button or menu list item) for the message digest function.

A further embodiment of the invention uses statistical observation of the pattern of creation of new hashes to identify sudden changes within a network. For example, if newly computed hash values are compared with stored hash values and a large number of copies of a specific hash value MD₁ can be seen to have changed, this implies that the corresponding copies of the resource represented by hash value MD₁ have also changed. This could mean that a group of users are upgrading from one file version to another (for example if MD₁ consistently changes to MD₂) or that a virus is spreading through the system. The latter is most likely if a large number of copies of MD₁ have remained unchanged for a long period and are then suddenly replaced by a large number of different hash values—indicating the probable spread of a polymorphic virus. The comparison of hash values can be used once again to determine which resources require a virus scan and which do not.

The monitoring of hash values to identify changes to files may be implemented for a set of decoy injectable files distributed throughout a network. The hash values for these files should never change, whereas other files may change due to upgrades, user modifications, etc. Therefore, any changes to the hash values representing a file on one of the systems in the network implies at least the need for a virus scan for that system. Use of dummy decoy files (referred to as ‘honey pots’) is well known for detection of computer hacking, but could also provide a warning of the presence of a virus. According to an embodiment of the invention, infectable files (such as a collection of small .exe files) are distributed within a randomly chosen subset of folders on a mail server. A virus could not easily identify the .exe files as decoys. The hash values for the decoy .exe files are stored on the system and the decoy locations and hash values are stored on the pool server. The local antivirus program checks the hashes of these files with the hashes stored at the pool server when performing a virus check of the system. If one of the hash values of a decoy file is seen to have changed, the virus scan coordinator running on the pool server generates an alert. The pool server may notify a system administrator, and instruct the system holding the decoy file to disconnect from the network or shut down. Such a check of hash values of decoy files may even identify the presence of a virus which is not yet recognizable by the virus definitions of the antivirus software running on the infected system, thereby enabling containment of a virus attack.

It is common within many organizations for antivirus policies to be implemented such that most systems are initially configured to perform virus checking on a particular default day such as Monday of each week. Although users can change this initial configuration, many users do not adjust configuration settings of background tasks. A virus released one day after such a default day for virus checks would have more chance of spreading though the organisation's computing environment—a window of opportunity of one week if users rely on their weekly default virus check. A solution to this potential vulnerability is to employ random (or pseudo-random) selection of a default day for each system's initial virus scan configuration settings. This may provide a more uniform distribution of virus scanning for systems within the organisation, and can spread the load on a virus-coordinating server over a number of days. An example of a qualified or ‘pseudo-random’ approach may involve excluding days such as weekends and public holidays when systems are not switched on. Alternatively, the initial configuration settings may be managed more actively to achieve a more uniform spread—such as by reducing the number of systems initially configured to perform default scanning on a Thursday if many users actively select Thursday as the day for performing background virus checks.

It will be clear to persons skilled in the art that additional variations and alternatives to the above-described embodiments are achievable within the scope of the present invention as set out in the claims.

1. A method for controlling scanning for computer viruses within a data processing network, comprising the steps of:
computing a set of hash values representing a set of resources;
in response to a requirement for a virus check, comparing the computed hash values to identify resources within said set of resources having matching hash values;
performing a virus scan for a first resource within said set of resources and, in response to the virus scan determining that the first resource is virus-free, recording a virus-free status for the first resource and the identified resources having hash values matching the hash value of the first resource.

2. The method of claim 1, wherein:
the steps of comparing the hash values, performing a virus scan, and recording a virus-free status are performed at a first data processing system within the network for a set of resources distributed across a plurality of data processing systems within the network.

3. The method of claim 1, wherein:
the steps of computing hash values for a resource are performed at a data processing system within the network at which the resource is stored, the method further comprising sending the computed hash values to said first data processing system.

4. The method of claim 2, further comprising:
forwarding an indication of the virus-free status to a plurality of data processing systems at which a resource matching the first resource is stored.

5. The method of claim 2, further comprising:
performing decontamination of the first resource at the first data processing system and forwarding a copy of the decontaminated first resource to data processing systems, within the plurality of data processing systems, storing an identified resource having a hash values matching the hash value of the first resource.

6. A method for controlling scanning for computer viruses within a data processing network, comprising the steps of:
receiving a set of hash values derived by applying a secure hash function to each of a set of resources;
storing the set of hash values;
in response to a requirement for a virus check, comparing the computed hash values to identify resources within said set of resources having matching hash values;
performing a virus scan for a first resource within said set of resources and, in response to the virus scan determining that the first resource is virus-free, recording a virus-free status for the first resource and the identified resources having hash values matching the hash value of the first resource.

7. The method of claim 6, wherein storing the received hash values comprises updating a repository of hash values representing a set of resources stored at each of a plurality of data processing systems within a network.

8. The method of claim 7, wherein comparing the computed hash values comprises comparing hash values for resources stored at each of the plurality of data processing systems to identify resources replicated across a set of said data processing systems, performing the virus scan for one of the replicas of a resource, and forwarding the result of the virus scan to each of the set of data processing systems for recordal in relation to a respective replica resource.

9. The mthod of claim 8, further comprising:
using the identification of replicated resources to generate a report of the distribution of replicas of a resource.

10. A method for controlling performance of an operation within a data processing network, comprising the steps of:
computing a set of hash values representing a set of resources;
in response to a requirement for performance of the operation, comparing the computed hash values to identify resources within said set of resources having matching hash values;
performing the operation in relation to a first resource within said set of resources and recording a result of the operation in association with the first resource and in association with identified resources having hash values matching the hash value of the first resource.

11. A method for controlling performance of an operation within a data processing network, comprising the steps of:
receiving a set of hash values derived by applying a secure hash function to each of a set of resources;
storing the set of hash values;
in response to a requirement for performance of the operation, comparing the computed hash values to identify resources within said set of resources having matching hash values;
performing the operation in relation to a first resource within said set of resources and recording a result of the operation in association with the first resource and identified resources having hash values matching the hash value of the first resource.

12. A data processing apparatus comprising:
a data processing unit;
a data storage unit;
a repository manager configured to store a set of hash values in at least one repository within the data storage unit, wherein the set of hash values are derived from a set of resources determined to be virus free; and
a virus scan coordinator for comparing the computed hash values to identify resources having matching hash values, for controlling performance of a virus scan for a first resource, and for responding to said virus scan determining that the first resource is virus-free by controlling the repository manager to record a virus-free status in association with the first resource and resources having hash values matching the hash value of the first resource.

13. A data processing apparatus comprising:
a data processing unit;
a data storage unit;
a repository manager configured to store a set of hash values in at least one repository within the data storage unit, wherein the set of hash values are derived from a set of resources determined to be virus free; and
a coordinator for coordinating performance of an operation by comparing the computed hash values to identify resources having matching hash values, for controlling performance of the operation for a first resource, and for controlling the repository manager to record a result of the operation in association with the first resource and resources having hash values matching the hash value of the first resource.

14. The data processing apparatus of claim 13, further comprising:
a plurality of operator programs, each configured to respond to instructions from said coordinator to perform a respective operation in relation to the first resource.

15. The data processing apparatus of claim 14, wherein the plurality of operator programs comprises a plurality of virus scanning programs.

16. The data processing apparatus of claim 14, wherein the plurality of operator programs comprises a plurality of virus-decontaminator programs.

17. The data processing apparatus of claim 13, further comprising a report generator for generating a report of the distribution of resources having hash values matching the hash value of the first resource.

18. A computer program product, comprising program code recorded on a recording medium, for controlling the performance of operations on a data processing system on which the program code executes, wherein the program code comprises:
a repository manager configured to store, in at least one repository, a set of hash values derived from a set of resources; and
a virus scan coordinator for comparing the computed hash values for the set of resources to identify resources having matching hash values, for controlling performance of a virus scan for a first resource, and for responding to a determination by said virus scan that the first resource is virus free by controlling the repository manager to record a virus-free status in respect of the first resource and resources having hash values matching the hash value of the first resource.

19. A method for controlling scanning for computer viruses within a data processing network, comprising the steps of:
receiving a set of hash values derived by applying a secure hash function to each of a set of resources;
storing the set of hash values;
in response to a requirement for a virus check, comparing the computed hash values to identify resources within said set of resources having matching hash values; performing a virus scan for a first resource within said set of resources and, in response to the virus scan determining that the first resource is virus-contaminated, recording a virus-contaminated status for the first resource and identified resources having hash values matching the hash value of the first resource.

20. The method of claim 19, wherein storing the set of hash values comprises updating a repository of hash values representing a set of resources stored at each of a plurality of data processing systems within a network.

21. The method of claim 20, wherein comparing the computed hash values comprises comparing hash values for resources stored at each of the plurality of data processing systems to identify resources replicated across a set of said data processing systems, performing the virus scan for one of the replicas of a resource, and forwarding the result of the virus scan to each of the set of data processing systems for recordal in relation to a respective replica resource.

22. A data processing apparatus comprising:
a data processing unit;
a data storage unit;
a repository manager configured to store a set of hash values in at least one repository within the data storage unit, wherein the set of hash values are derived from a set of resources determined to be virus free; and
a virus scan coordinator for comparing the computed hash values to identify resources having matching hash values, for controlling performance of a virus scan for a first resource, and for responding to said virus scan determining that the first resource is virus-contaminated by controlling the repository manager to record a virus-contaminated status in association with the first resource and resources having hash values matching the hash value of the first resource.

23. A computer program product, comprising program code recorded on a recording medium, for controlling the performance of operations on a data processing system on which the program code executes, wherein the program code comprises:
a repository manager configured to store, in at least one repository, a set of hash values derived from a set of resources; and
a virus scan coordinator for comparing the computed hash values for the set of resources to identify resources having matching hash values, for controlling performance of a virus scan for a first resource, and for responding to a determination by said virus scan that the first resource is virus-contaminated by controlling the repository manager to record a virus-contaminated status in respect of the first resource and resources having hash values matching the hash value of the first resource.
